(19) United States
(12) Patent Application Publication
(10) Pub. No.: US 2004/0242069 A1
(43) Pub. Date: Dec. 2, 2004

(54) Metal shielding shell for electric connector

(75) Inventor: Hui-Ping Yang, Pingtung Hsien (TW)

Correspondence Address: BACON & THOMAS, PLLC, 625 SLATERS LANE, FOURTH FLOOR, ALEXANDRIA, VA, 22314

(73) Assignee: SPEED TECH CORP., Taoyuan Hsien (TW)

(21) Appl. No.: 10/800,621

(22) Filed: Mar. 16, 2004

(30) Foreign Application Priority Data
May 26, 2003 (TW) 092209638

(51) Int. Cl. H01R 13/648

(52) U.S. Cl. 439/607

(57) ABSTRACT

A metal shielding shell covered on an electrically insulative terminal holder block holding a set of terminal is disclosed having two guide rods bilaterally extended from the front bonding side thereof for insertion into respective through holes on a circuit board for enabling the terminals to be bonded to respective contacts at the circuit board, and two protruded portions extended from the two opposite lateral sides thereof for grounding.

### BACKGROUND OF THE INVENTION

1. Field of the Invention

The present invention relates to an electric connector and more particularly, to a metal shielding shell for electric connector that has two front guide rods for positioning during installation of the electric connector in a circuit board.

2. Description of the Related Art

Following fast development of computer and electronic technology, a variety of electronic products have been created and intensively used in different fields. In consequence, different connectors are required for connection between peripheral apparatus and host systems. Suppliers are trying hard to design new and stable electric connectors for use in computers and other electronic apparatus that can easily and quickly be assembled. FIG. 5 illustrates an electric connector constructed according to the prior art.

According to FIG. 5, prior art, the electric connector comprises an electrically insulative housing A, a terminal holder block B mounted inside the housing A, a plurality of terminals C installed in the terminal holder block B, and two grounding plates A1 bilaterally extended out of the housing A. During installation, the electric connector is put on a circuit board D, keeping the grounding plates A1 closely attached to the circuit board D and the terminals C respectively attached to the respective contact fingers D1 of the circuit board D, and then the grounding plates A1 and the terminals C are respectively soldered to the circuit board D. The prior electric connector has numerous drawbacks as:

1. The electric connector tends to slip on the circuit board D during installation, resulting in difficulty of the bonding of the terminals C to the respective contact fingers D1.

2. Because the electric connector is fastened to the circuit board D by surface mounting technique, the soldered points tend to be disconnected by vibration or other external factors, causing a malfunction.

3. Because no protective means is provided to protect the terminals C, the terminals C may be deformed or damaged during fabrication or transportation.

### SUMMARY OF THE INVENTION

The present invention has been accomplished under the circumstances in view. It is therefore an object of the present invention to provide a metal shielding shell for electric connector, which comprises two front guide rods forwardly extended from the front bonding side thereof for positioning in respective through holes on the circuit board to mount, for enabling the terminals to be bonded to respective contacts at the circuit board. It is another object of the present invention to provide a metal shielding shell for electric connector, which has two front guide rods bilaterally extended from the front bonding side thereof that protect the bonding ends of the terminals during transportation. It is still another object of the present invention to provide a metal shielding shell for electric connector, which has two front guide rods for positioning that can be bent inwards/outwards to fit any of a variety of circuit boards.

### BRIEF DESCRIPTION OF THE DRAWINGS

FIG. 1 is an elevational view of an electric connector having a metal shielding shell constructed according to the present invention.

FIG. 2 is a view showing the positioning of the front guide rods of the metal shielding shell on a circuit board before assembling according to the present invention.

FIG. 3 is a view of FIG. 3 after assembling.

FIG. 4 illustrates the electric connector installed in another circuit board according to the present invention.

FIG. 5 illustrates an electric connector installed in a circuit board according to the prior art.

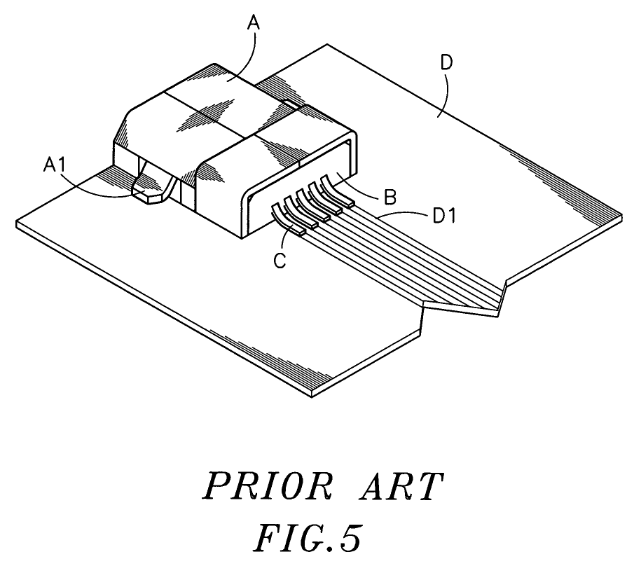

### DETAILED DESCRIPTION OF THE PREFERRED EMBODIMENT

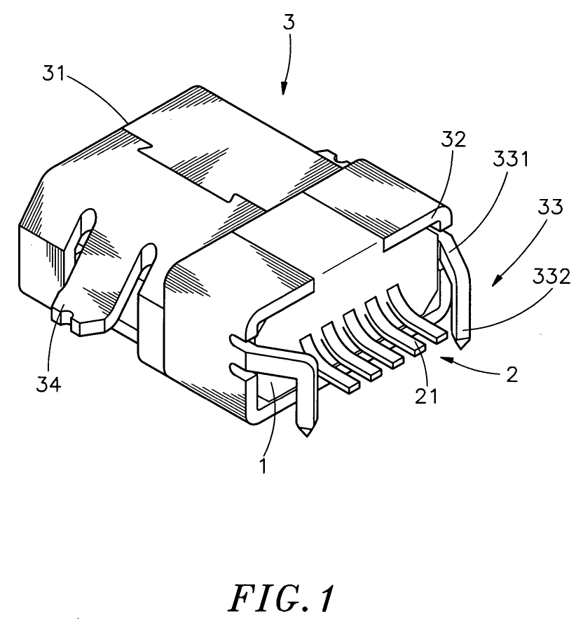

Referring to FIG. 1, a metal shielding shell 3 is covered on an electrically insulative terminal holder block 1, which holds a set of terminals 2. The metal shielding shell 3 has a rear connection side 31, a front bonding side 32 opposite to the rear connection side 31, two guide rods 33 bilaterally extended from the front bonding side 32 toward each other, each guide rod 33 having a horizontal base portion 331 formed integral with the front bonding side 32 and a vertical mounting portion 332 downwardly extended from the horizontal base portion 331, and two protruding portions 34 respectively extended from two opposite lateral sides adjacent to the rear connection side 31 for grounding. The mounting portion 332 may be terminated in a conical tip or round tip. The terminals 2 each have a bonding end 21 forwardly extended out of the terminal holder block 1.

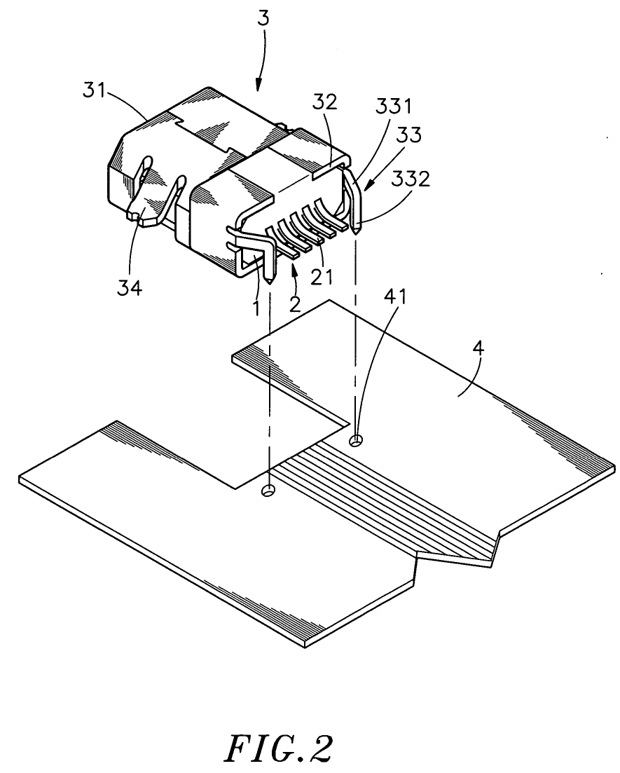

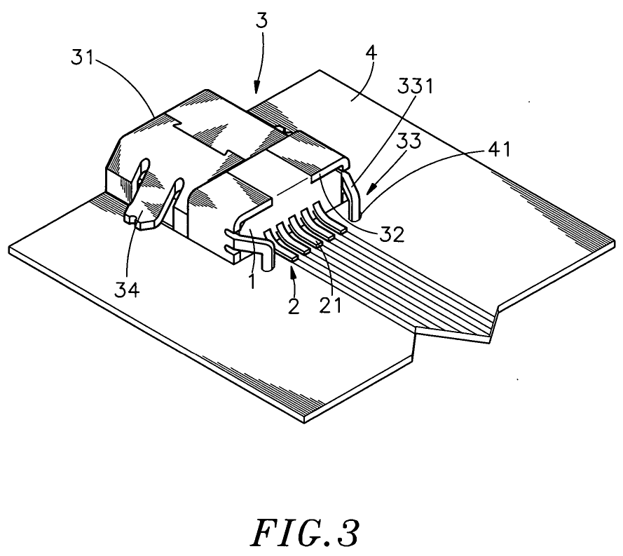

Referring to FIGS. 2 and 3, during installation, the mounting portions 332 of the guide rods 33 of the metal shielding shell 3 are plugged into respective through holes 41 of the circuit board 4, holding the bonding ends 21 of the terminals 2 in contact with respective contact fingers of the circuit board 4 and the protruding portions 34 closely attached to the circuit board 4 for grounding, and therefore the bonding ends 21 of the terminals 2 and the protruding portions 34 can easily and accurately be soldered to the respective contact fingers and surface of the circuit board 4.

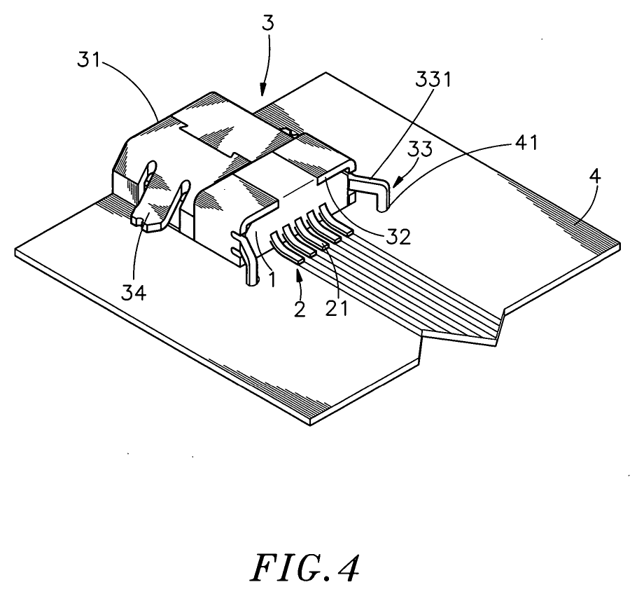

Referring to FIG. 4, the guide rods 33 can respectively be turned outwards subject to the pitch between the two through holes 41 of the circuit board 4. Therefore, the metal shielding shell 3 fits different circuit boards.

As indicated above, the metal shielding shell of the present invention has the following advantages:

1. The metal shielding shell has two front guide rods for positioning on the circuit board to install, keeping the terminals and the protruding portions in position for soldering to respective contacts at the circuit board.

2. The front guide rods of the metal shielding shell give a protection to the bonding ends of the terminals during transportation or manufacturing process.

A prototype of metal shielding shell for electric connector has been constructed with the features of the annexed drawings of FIGS. 1˜4. The metal shielding shell for electric connector functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A metal shielding shell covered on an electrically insulative terminal holder block holding a set of terminals, comprising two guide rods bilaterally extended from a front bonding side thereof for insertion into respective through holes on a circuit board for enabling said terminals to be bonded to respective contacts at said circuit board, said guide rods each having a base formed integral with the front bonding side of said metal shielding shell and a mounting portion extended from said base and curved in one direction.

2. The metal shielding shell as claimed in claim 1, wherein said front guide rods are obliquely extended from said front bonding side in direction toward each other.

3. The metal shielding shell as claimed in claim 1, wherein said front guide rods are obliquely outwardly extended from said front bonding side.

4. The metal shielding shell as claimed in claim 1, wherein the mounting portion of each said guide rod has a conical tip.

5. The metal shielding shell as claimed in claim 1, wherein the mounting portion of each said guide rod has a round tip.

6. The metal shielding shell as claimed in claim 1, further comprising two protruded portions respectively extended from two opposite lateral sides thereof for grounding.
